(19) United States
(12) Patent Application Publication
(10) Pub. No.: US 2018/0370085 A1
(43) Pub. Date: Dec. 27, 2018

(54) Method for Molding Three-Dimensional Toy

(71) Applicant: XIELE ELECTRONIC & PLASTIC LIMITED, Dongguan City (CN)

(72) Inventor: Xiu-Ying Yang, Dongguan City (CN)

(21) Appl. No.: 15/633,823

(22) Filed: Jun. 27, 2017

(51) Int. Cl. B29C 41/02; B29C 41/00; B29C 35/08; B29C 33/00

(52) U.S. Cl. CPC B29C 41/02; B29C 41/003; B29C 35/0805; B29K 2075/00; B29C 2035/0827; B29C 2033/0005; B29C 33/00

(57) ABSTRACT

A method for molding a three-dimensional toy includes selecting an upper die and a lower die each having a three-dimensional molding cavity, spreading a photosensitive molding glue on the inner wall of the molding cavity of each of the upper die and the lower die, closing the upper die and the lower die, placing the upper die and the lower die in an ultraviolet lamp box or irradiating the upper die and the lower die under the sun to solidify the photosensitive molding glue so as to mold a three-dimensional toy, and opening the upper die and the lower die to remove the three-dimensional toy from the upper die and the lower die.

### BACKGROUND OF THE INVENTION

### 1. Field of the Invention

The present invention relates to a craft technology and, more particularly, to a method for molding a three-dimensional toy.

### 2. Description of the Related Art

A conventional three-dimensional toy, such as a plasticine, a color clay, a sandy clay and the like, has a soft feature and is made to have various shapes, thereby providing an amusement effect to the children. However, the conventional three-dimensional toy is dried very slowly, thereby wasting the shaping time. In addition, the conventional three-dimensional toy is easily wrinkled and deformed, and does not have a prominent spatial appearance. Further, the conventional three-dimensional toy is cured at a high energy, thereby wasting the energy. Further, the conventional three-dimensional toy produces great odor, and easily excites the user's skin.

### BRIEF SUMMARY OF THE INVENTION

The primary objective of the present invention is to provide a method for molding a three-dimensional toy quickly.

In accordance with the present invention, there is provided a method for molding a three-dimensional toy quickly, comprising a first step of selecting an upper die and a lower die each having a three-dimensional molding cavity, a second step of spreading a photosensitive molding glue on an inner wall of the molding cavity of each of the upper die and the lower die, a third step of closing the upper die and the lower die, a fourth step of placing the upper die and the lower die in an ultraviolet lamp box or irradiating the upper die and the lower die under the sun to solidify the photosensitive molding glue so as to mold a three-dimensional toy, and a fifth step of opening the upper die and the lower die to remove the three-dimensional toy from the upper die and the lower die.

Preferably, each of the upper die and the lower die is light permeable.

Preferably, the upper die has an upper end provided with at least three positioning grooves, and the lower die has an upper end provided with at least three positioning projections corresponding to the at least three positioning grooves of the upper die.

Preferably, the photosensitive molding glue has a formula including aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and methacrylic acid with a proportion of 23-36%.

Preferably, the photosensitive molding glue is spread unevenly on the inner wall of the molding cavity of each of the upper die and the lower die.

Preferably, the ultraviolet lamp box has a power of 0.1-5 W.

Preferably, the photosensitive molding glue in the upper die and the lower die has an irradiating and solidifying time of one to ten minutes (1-10 min).

According to the primary advantage of the present invention, the photosensitive molding glue has a fast curing feature so that the three-dimensional toy is molded quickly.

According to another advantage of the present invention, the method of the present invention makes a three-dimensional toy with various types and shapes by provision of the molding cavity of each of the upper die and the lower die, thereby satisfying the diverse requirements of the consumers.

According to a further advantage of the present invention, the three-dimensional toy has a smooth surface and has an outstanding spatial appearance, thereby attracting attention of the children.

According to a further advantage of the present invention, the photosensitive molding glue is cured at a low energy, thereby saving the energy.

According to a further advantage of the present invention, the photosensitive molding glue produces little odor, and does not excite the user's skin.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a schematic view showing a die structure for molding a three-dimensional toy in accordance with the preferred embodiment of the present invention.

### DETAILED DESCRIPTION OF THE INVENTION

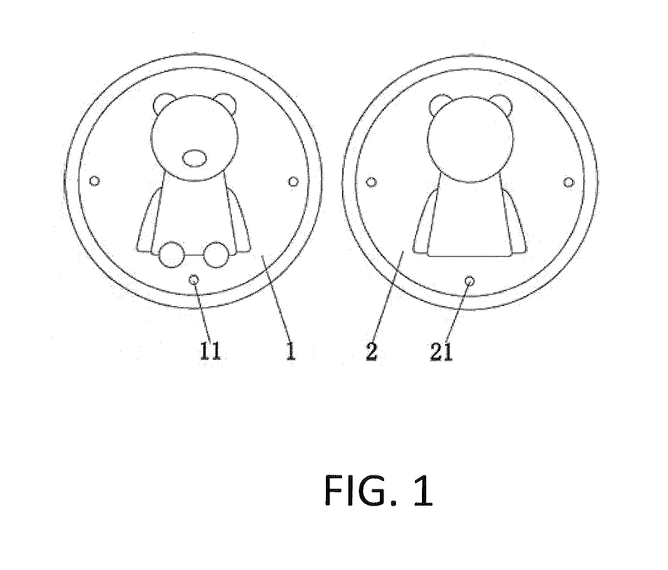

Referring to FIG. 1, a method for molding a three-dimensional toy quickly in accordance with the preferred embodiment of the present invention comprises a first step of selecting an upper die 1 and a lower die 2 each having a three-dimensional molding cavity, a second step of spreading a photosensitive molding glue on an inner wall of the molding cavity of each of the upper die 1 and the lower die 2, a third step of closing the upper die 1 and the lower die 2, a fourth step of placing the upper die 1 and the lower die 2 in an ultraviolet lamp box or irradiating the upper die 1 and the lower die 2 under the sun to solidify the photosensitive molding glue so as to mold a three-dimensional toy, and a fifth step of opening the upper die 1 and the lower die 2 to remove the three-dimensional toy from the upper die 1 and the lower die 2.

In the preferred embodiment of the present invention, each of the upper die 1 and the lower die 2 is light permeable.

In the preferred embodiment of the present invention, the upper die 1 has an upper end provided with at least three positioning grooves 11, and the lower die 2 has an upper end provided with at least three positioning projections 21 corresponding to the at least three positioning grooves 11 of the upper die 1.

The photosensitive molding glue has a formula including aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and methacrylic acid with a proportion of 23-36%.

In the preferred embodiment of the present invention, the photosensitive molding glue includes aliphatic urethane acrylate with a proportion of 52%, photoinitiator with a proportion of 8%, gas phase silicon dioxide with a proportion of 3%, propylene glycol glycerin triacrylate with a proportion of 14%, and methacrylic acid with a proportion of 23%.

Alternatively, the photosensitive molding glue includes aliphatic urethane acrylate with a proportion of 50%, photoinitiator with a proportion of 10%, gas phase silicon dioxide with a proportion of 6%, propylene glycol glycerin triacrylate with a proportion of 8%, and methacrylic acid with a proportion of 26%.

Alternatively, the photosensitive molding glue includes aliphatic urethane acrylate with a proportion of 51%, photoinitiator with a proportion of 9%, gas phase silicon dioxide with a proportion of 5%, propylene glycol glycerin triacrylate with a proportion of 10%, and methacrylic acid with a proportion of 25%.

In the preferred embodiment of the present invention, the photosensitive molding glue is spread unevenly on the inner wall of the molding cavity of each of the upper die 1 and the lower die 2.

In the preferred embodiment of the present invention, the ultraviolet lamp box has a power of 0.1-5 W.

In the preferred embodiment of the present invention, the photosensitive molding glue in the upper die 1 and the lower die 2 has an irradiating and solidifying time of one to ten minutes (1-10 min).

Accordingly, the method of the present invention makes a three-dimensional toy with various types and shapes by provision of the molding cavity of each of the upper die 1 and the lower die 2, thereby satisfying the diverse requirements of the consumers. In addition, the photosensitive molding glue has a fast curing feature under a cold light of an LED, so that the three-dimensional toy is molded quickly. Further, the three-dimensional toy has a smooth surface and has an outstanding spatial appearance, thereby attracting attention of the children. Further, the photosensitive molding glue is solidified under the power of 0.1-5 W, so that the photosensitive molding glue is cured at a low energy, thereby saving the energy. Further, the photosensitive molding glue produces little odor, and does not excite the user's skin.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A method for molding a three-dimensional toy, comprising:
a first step of selecting an upper die and a lower die each having a three-dimensional molding cavity;
a second step of spreading a photosensitive molding glue on an inner wall of the molding cavity of each of the upper die and the lower die;
a third step of closing the upper die and the lower die;
a fourth step of placing the upper die and the lower die in an ultraviolet lamp box or irradiating the upper die and the lower die under the sun to solidify the photosensitive molding glue so as to mold a three-dimensional toy; and
a fifth step of opening the upper die and the lower die to remove the three-dimensional toy from the upper die and the lower die.

2. The method of claim 1, wherein each of the upper die and the lower die is light permeable.

3. The method of claim 1, wherein the upper die has an upper end provided with at least three positioning grooves, and the lower die has an upper end provided with at least three positioning projections corresponding to the at least three positioning grooves of the upper die.

4. The method of claim 1, wherein the photosensitive molding glue has a formula including aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and methacrylic acid with a proportion of 23-36%.

5. The method of claim 1, wherein the photosensitive molding glue is spread unevenly on the inner wall of the molding cavity of each of the upper die and the lower die.

6. The method of claim 1, wherein the ultraviolet lamp box has a power of 0.1-5 W.

7. The method of claim 1, wherein the photosensitive molding glue in the upper die and the lower die has an irradiating and solidifying time of one to ten minutes (1-10 min).
